(19) United States
(12) Patent Application Publication
(10) Pub. No.: US 2018/0178112 A1
(43) Pub. Date: Jun. 28, 2018

(54) TRADING CARD GAME SYSTEM AND METHOD

(71) Applicant: Robert Guarino, Alliston (CA)

(72) Inventor: Robert Guarino, Alliston (CA)

(21) Appl. No.: 15/388,685

(22) Filed: Dec. 22, 2016

(51) Int. Cl. A63F 1/00; A63F 1/04; A63F 13/822

(52) U.S. Cl. CPC A63F 1/00; A63F 1/04; A63F 2300/807; A63F 2001/008; A63F 13/822

(57) ABSTRACT

A game system relating to multi-player card games, the game system including: a game-board module having a plurality of peripheral edges, the plurality of peripheral edges containing at least one abuttable edge configured to be placeable in abutment with at least one other abuttable edge of the game system. In addition, the game-board module includes a first surface having a plurality of full spaces depicted thereon, each one identifying a positional piece location, the plurality of full spaces arranged in rows, and a plurality of half spaces, each one identifying one half of a positional piece location, the plurality of half spaces contiguous with the at least one abuttable edge and configured to form full spaces when the abuttable edge is abutted with at least one other abuttable edge of the game system.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present disclosure relates generally to the field of trading card game existing art and more specifically relates to customizable game boards and associated trading card games.

### 2. DESCRIPTION OF RELATED ART

Collectible card games, also called a trading card games are universally popular and take a wide variety of forms. The games are generally played in a match or in rounds, wherein the players select groups of cards that are used in competitive gameplay. In general, the goal of each player is to use the strength of their respective group of selected cards to reduce strength of the opposing player to a point where they must leave the game. The strategies and tactics used during the competitive gameplay are in accordance with the rules established for the game.

No known trading card games use a modular and customizable game board for gameplay. For example, U.S. Pat. No. 5,662,332 to Garfield relates to a novel method of game play and game components that in one embodiment are in the form of trading cards. However, the game components may take other forms, such as a board game, or the game may be played in different media, such as electronic games, video games, computer games, and interactive network. In one version, the game components comprise energy or mana cards and command or spell cards having commands or spells associated therewith that utilize the energy to enable a player to attack, defend and modify the effect of other mana cards, spell cards, and the fundamental rules of play. The goal of the game is to reduce the life points of other players to a level below one. In this game of strategy and chance, players construct their own library of cards, preferably from trading cards, and play their library or deck of cards against the deck of cards of an opposing player. Cards may be obtained from retail outlets, trading with other players or collectors, and winning cards at games and tournaments.

The worldwide popularity of such trading-card games creates a constant demand for new games and methods of use, particularly those having unique and compelling gameplay and which may be acquired at a reasonable cost. Thus, there remains opportunities in the field to develop new games and methods of use to fill this constant need, especially trading-card games utilizing modular and customizable game boards to promote more defined strategic, orderly, and enjoyable gameplay.

### BRIEF SUMMARY OF THE INVENTION

In view of the foregoing disadvantages inherent in the known trading card game art, the present disclosure provides a novel trading card game system and method. The general purpose of the present disclosure, which will be described subsequently in greater detail, is to provide a trading card game system and method.

In accordance with a preferred embodiment hereof, this disclosure provides a game system relating to multi-player card games, the game system including: a game-board module. The game-board module includes a plurality of peripheral edges containing at least one abuttable edge configured to be placeable in abutment with at least one other abuttable edge of the game system. The game-board module also includes a first surface having depicted thereon a plurality of full spaces each one identifying a positional piece location (game card location). The plurality of full spaces are arranged in rows. In addition, the game-board module has a plurality of half spaces, each one identifying one half of a positional piece location. The plurality of half spaces are contiguous with the abuttable edge and configured to form full spaces when the abuttable edge is abutted with at least one other abuttable edge of the game system.

Moreover, it provides such a game system wherein the rows are in a contiguous relationship. Additionally, the plurality of full spaces of a row are arranged in a staggered relationship with respect to the plurality of full spaces of an adjacent row. Also, the full spaces are substantially square. In addition, it provides such a game system further including first distinctive indicia defining at least one command zone within the plurality of full spaces. And, it provides such a game system wherein the at least one command zone adjoins at least one of the peripheral edges.

The game system further includes second distinctive indicia defining at least one neutral-zone half-space within the plurality of half spaces. Even further, each abuttable edge of the game-board module includes an edge length; and the at least one neutral-zone half-space is located near a midpoint of the edge length. Moreover, the neutral-zone half-space is configured to form at least one neutral-zone full-space when the abuttable edge is abutted with the at least one other abuttable edge of the game system.

Additionally, it provides such a game system wherein the game-board module further includes a plurality of planar sections hingedly joined together such that the sections can be folded so as to overlie one another or unfolded to lie in a substantially common plane. When folded, a portion of the full spaces form at least one set of half spaces and the set of half spaces are contiguous with the at least one new abuttable edge. Moreover, the half spaces are configured to form a set of full spaces when abutted with at least one other abuttable edge of the game system. In addition, the game-board modules may be permanently joined together.

Also, it provides such a game system further including a second surface having depicted thereon a second plurality of full spaces each one identifying a positional piece location, the second plurality of full spaces are arranged in rows, and a second plurality of half spaces, each one identifying one half of a positional piece location, the plurality of half spaces contiguous with the at least one abuttable edge and configured to form a set of full spaces when the abuttable edge is abutted with at least one other abuttable edge of the game system. In addition, it provides such a game system further including a leaflet module including a plurality of peripheral leaflet edges, the plurality of peripheral leaflet edges containing at least one abuttable edge configured to be placeable in abutment with at least one other abuttable edge of the game system, a first leaflet surface having depicted thereon a third plurality of full spaces each one identifying a positional piece location, the third plurality of full spaces arranged in rows, and a third plurality of half leaflet spaces, each one identifying one half of a positional piece location, the third plurality of half leaflet spaces contiguous with the at least one abuttable edge of the leaflet module and configured to form a group of full spaces when the abuttable edge of the leaflet module is abutted with at least one other abuttable edge of the game system. Moreover, the game-board modules and the leaflet modules may be permanently joined together.

Additionally, it provides such a game system wherein each of the full spaces of the game system is about 89 millimeters square. Further, the game system includes thematic indicia graphically depicting at least one theme related to the multi-player card game. Even further, it provides such a game system wherein the game-board module is electronically displayed.

Even further, it provides such a game system further including set of instructions; and wherein the game system is arranged as a kit. Moreover, the game system further includes at least one set of game cards each game card of the set including at least one game-card attribute, the at least one game-card attribute defining an action in accordance with the game rules such that the gameplay proceeds according to a series of steps taken by each player with respect to the games-card attributes in active play, the at least one game-card attribute at least enabling a mastery scheme allowing each player to assemble, from the set of trading cards, a custom subset of the game cards, the mastery scheme establishing a class-based structure within the custom subset at least including a hero-class and at least one other game-card class, a command-zone scheme by which players may position a game card from the hero-class in at least one command zone within a field of play, the game card from the hero-class, when so positioned, is capable of leveraging at least one game-card attribute of the at least one other game-card class within the field of play, and a resource scheme allowing a player to cost turn-by-turn gameplay actions.

In accordance with another preferred embodiment hereof, this disclosure provides a method relating to strategy games utilizing game cards, the method including the steps of: providing a set of game rules governing gameplay within a game-card strategy game; providing a set of the game cards useable during the gameplay, each game card of the set including at least one game-card attribute, the at least one game-card attribute defining an action in accordance with the game rules such that the gameplay proceeds according to a series of steps taken by each player with respect to the games-card attributes in active play, the at least one game-card attribute at least enabling a mastery scheme allowing each player to assemble, from the set of trading cards, a custom subset of the game cards. The mastery scheme establishes a class-based structure within the custom subset at least including a hero-class and at least one other game-card class, a command-zone scheme by which players may position a game card from the hero-class in at least one command zone within a field of play, the game card from the hero-class, when so positioned, is capable of leveraging at least one game-card attribute of the at least one other game-card class within the field of play, and a resource scheme allowing a player to cost turn-by-turn gameplay actions; providing a set of modular game-board components, the set of modular game-board components capable of forming the field of play on which the game-card strategy game may be played, the modular game board including features enabling the mastery scheme, the command-zone scheme, and the resource scheme during the gameplay. Even further, it provides such a method further including the steps of: providing additional modular game-board components usable to alter the field of play; and providing additional game cards usable to alter the composition of game-card attributes within the set.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, a trading card game system and method, constructed and operative according to the teachings of the present disclosure.

FIG. 1 is a perspective view of a game system during an ‘in-use’ condition, according to an embodiment of the disclosure.

FIG. 2 is a top plan view of a game-board module of the game system of FIG. 1, according to an embodiment of the present disclosure.

FIG. 3 is a top plan view of two game-board modules combined to form a complete game board, according to an embodiment of the present disclosure.

FIG. 4 is a bottom plan view of the game board of FIG. 3, according to an embodiment of the present disclosure.

FIG. 5 is a partial side view of the game-board module of FIG. 1, according to an embodiment of the present disclosure.

FIG. 6 is a top plan view of a four player game board of the game system using folded game-board modules, according to an embodiment of the present disclosure.

FIG. 7 is a top plan view of a leaflet expansion module of the game system, according to an embodiment of the present disclosure.

FIG. 8 is a bottom plan view of the leaflet expansion module of FIG. 7, according to an embodiment of the present disclosure.

FIG. 9 is a top plan view of an alternate leaflet expansion module of the game system, according to an embodiment of the present disclosure.

FIG. 10 is a bottom plan view of the alternate leaflet expansion module of FIG. 9, according to an embodiment of the present disclosure.

FIG. 11 is a plan view of an alternate game board using the leaflet expansion module of FIG. 9, according to an embodiment of the present disclosure.

FIG. 12 is a plan view of an alternate game board using both sides of the game-board module of FIG. 1, according to an embodiment of the present disclosure.

FIG. 13 is a top plan view of a multi-player game board of the game system using folded game-board modules, according to an embodiment of the present disclosure.

FIG. 14 is a diagram illustrating a relational hierarchy of game-card attributes, according to an embodiment of the present disclosure.

FIG. 15 is a diagram illustrating example gameplay of the game system, according to an embodiment of the present disclosure.

FIG. 16 is a diagram illustrating an example arrangement of game-card attributes of a game card, according to an embodiment of the present disclosure.

FIG. 17 is a top plan view of an alternate game board of the game system using separate Command Zone modules, according to another embodiment of the present disclosure.

FIG. 18 is a flow diagram illustrating a method relating to strategy games utilizing game cards, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to card or tile games using a game-board structure and more particularly to a trading card game system and method as used to improve gameplay in various trading card strategy games.

Generally, the present disclosure relates to a trading card game system and method for two or more players. The system may include a modular game board and may further include a set of trading cards or collectable cards, which may be adapted as strategic positional pieces, or for use with the game board, or as positional pieces in other games. The customizable multi-part game board is a primary feature of the present system and may be combined with other board modules of the same design or expanded with the addition of leaflet modules.

The modular game board provides a platform on which a Trading Card Game (TCG) or Collector Card Game (CCG) cards may be played as strategically moveable and positional pieces. The modular game board is designed for a new TCG game, aspects of which are disclosed herein.

The modular game board is composed of two or more game-board modules. In the most basic configuration, the game-board module is one-half of a two-player field that when put together, creates a field of play for the associated trading-card game. The field of play is customizable using the basic game-board modules or by adding additional modules. If more than two players participate, or if a larger field is desired, the sides of each game-board module may fold under to allow alignment with additional board modules, also having folded sides. An aligned leaflet module may also be inserted to further enlarge the field of play. Additionally, there is an alternate design on the underside that may be used to cap the left and right ends of a folded board for more configurations. The game board, together with a player's deck of cards, is relatively compact and easy for players to transport when meeting for matches.

The spaces of the game board are offset in a brick-like running-bond pattern, ensuring there are no “Blind Spots” or “Holes” within the perceivable scope of any one position. This creates a more realistic “Cone” of range or line of sight that is suited for play with TCG or similar cards. Only an assignment of range and movement values (such as the ones developed for the game specifically designed for this board) would need to be attributed to each card. Each player's board may also represent their territory (with, for example, a graphic setting), where certain limitations or advantages may influence subjects in that territory. These preferred features make for an ideal, dynamic platform players of TCG's or similar games. The system provides a unique level of customization and may be digitally adapted or rendered across various electronic-device platforms.

The modular game-board design is suited to varying strategy games applications involving positionally-relevant pieces. The associated trading-card game disclosed herein has been designed with simple and unique methods of play. This trading-card game, in combination with the modular game board, provides game play that is able to maintain the viability of key-word mechanics, customization of deck strategies, and modifying effects that are associated with the deep, yet easy-to-understand, strategies attributed to the genre. The present system enables a more realistic interpretation of game play within the TCG or CCG genre of games.

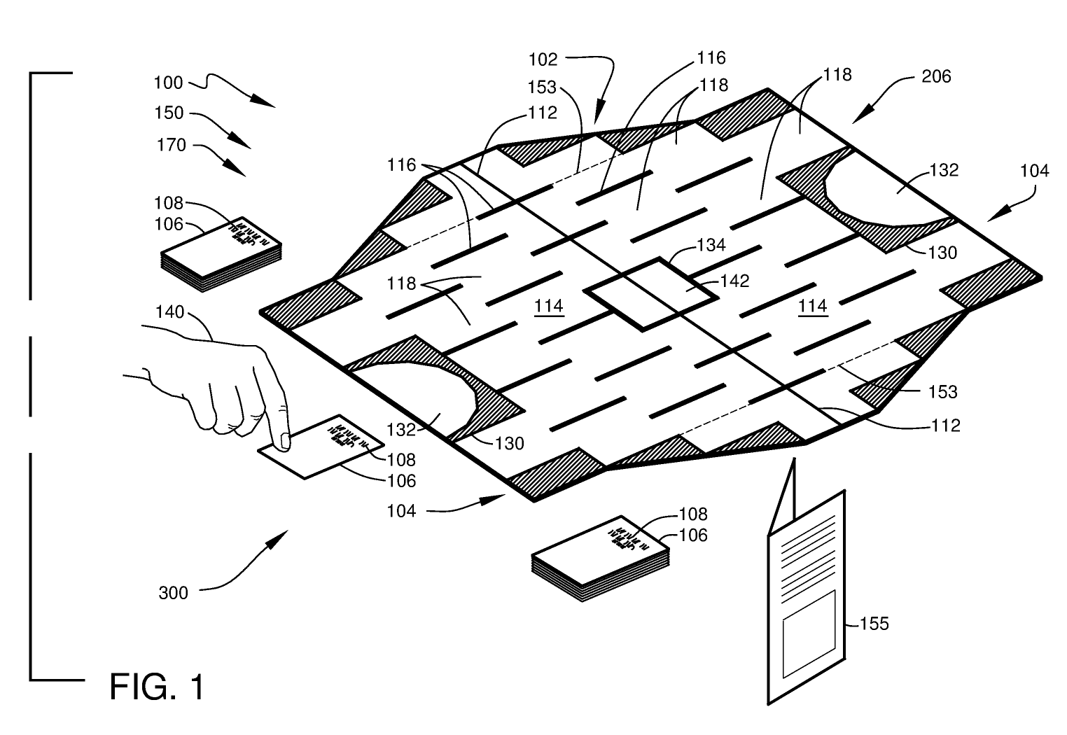

Referring now more specifically to the drawings by numerals of reference, there is shown in FIGS. 1-18, various views of a game system 100. FIG. 1 is a perspective view of a game system 100 during an ‘in-use’ condition 150, according to an embodiment of the disclosure. Here, the game system 100 may be beneficial for use by a user 140 in playing various trading card strategy games. As illustrated, the game system 100 may include a customizable game board 102 assembled from two or more game-board modules 104. The game-board modules 104 may include a wide range of configurations to allow the user 140 to assemble numerous variants of the game board 102. It is noted that the game-board module 104 of FIG. 1 may be used as a “Standard Duel” or “Quick Match” board for quick matches between players. It is further noted that each of the below-described the game-board modules and associated board elements may be permanently joined together to form a non-modular unified whole, if desired.

The game system 100 may further include a set of positional pieces associated with at least one strategy game usable with the customizable game board 102. In the following disclosure, the positional pieces are depicted as game cards 106; however, it should be noted that the positional pieces may also include other game-piece types, such as, for example, tokens, geometric shapes, objects, miniature figures, etc. Game cards 106 may be imprinted with a set of markings defining one or more game-card attributes 108. The game-card attributes 108 may indicate potential player actions available during the gameplay, in accordance with the game rules. The game-card attributes 108 are structured such that the gameplay proceeds according to a series of steps taken by each player with respect to the game-card attributes 108 in active play.

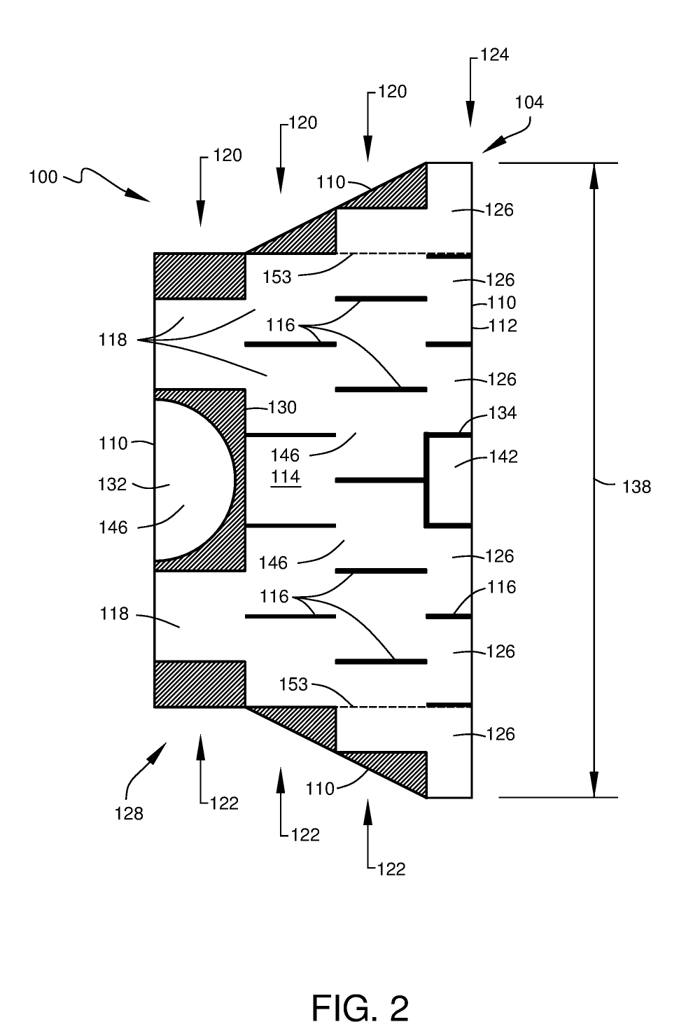

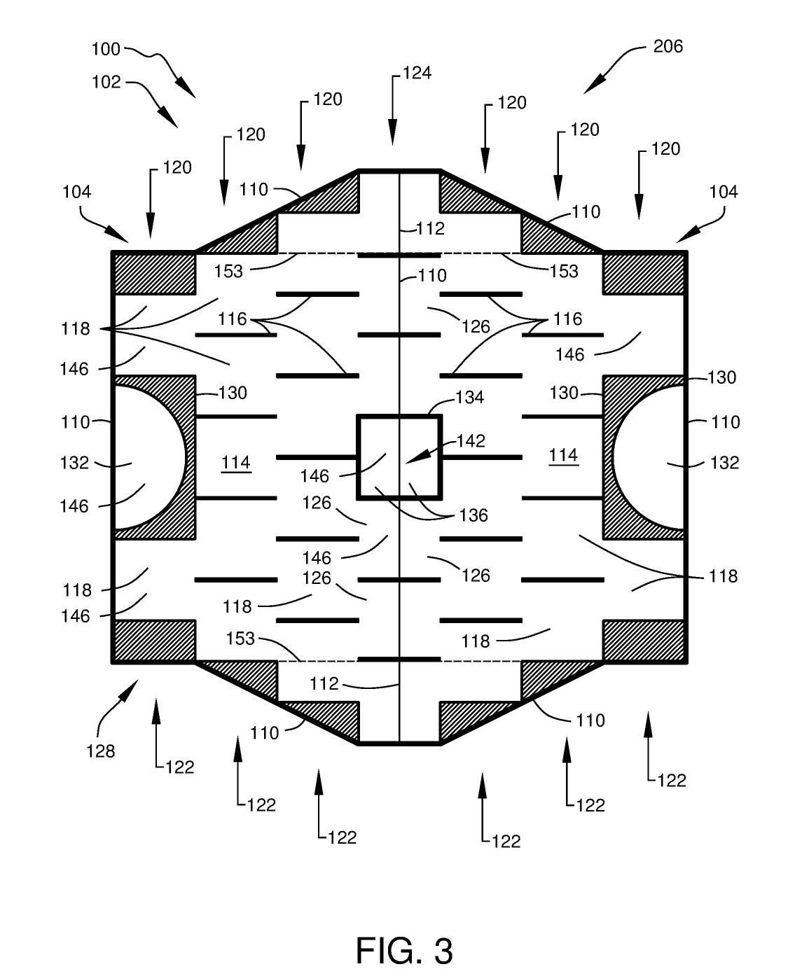

FIG. 2 is a top plan view of a game-board module 104 of the game system 100 of FIG. 1, according to an embodiment of the present disclosure. FIG. 3 is a top plan view of two game-board modules 104 combined to form a complete game board 102, according to an embodiment of the present disclosure. In the most basic configuration, the game-board module 104 is one-half of a two-player field that when put together, creates a generally-octagonal shape with unequal sides, as shown in FIG. 3

The game-board module 104 includes a plurality of peripheral edges 110 including at least one abuttable edge 112 configured to be placeable in abutment with at least one other abuttable edge 112 of the game system 100, as shown. Each game-board module 104 may include a first surface 114 containing graphical delineations, including an arrangements of parallel lines or hash marks 116 defining a plurality of full spaces 118 for the placement of game cards 106 during gameplay. The plurality of full spaces 118 are arranged in rows 120, as shown. The rows 120 extend from one side of the board to the other and are referred to as battle lines 122. The closest battle line 122 to each player is referred to as their first line, the next their second line, the next their third line etc. In this configuration, the fourth line is the mid-point between the opposing sides and is referred to as the neutral line 124.

In addition, the game-board module 104 includes a group of half spaces 126, each one identifying one half of a positional piece location. The plurality of half spaces 126 fall along the neutral line 124 and are contiguous with the abuttable edge 112 and configured to form full spaces 118 when the abuttable edge 112 is abutted with at least one other abuttable edge 112 of the game system 100, as shown in FIG. 3.

The rows 120 of full spaces 118 and half spaces 126 are arranged in a contiguous relationship, as shown. The plurality of full spaces 118 of a row 120 are arranged in a staggered relationship 128 with respect to the plurality of full spaces 118 of an adjacent row 120. Similarly, the row of half spaces 126 are arranged staggered relationship 128 with respect to the plurality of full spaces 118 of the adjacent row of full spaces 118. This offset arrangement of spaces reduces “Blind Spots” or “Holes” in the perceptible range of play. Thus, the layout of the modular game board 102 pushes action forward, hastening a conclusion for quicker matches. For example, if the first battle line contains seven spaces, a player may “stash” or “hide” allies they call in the corner, thus dragging out playing time. Even in larger configurations, the “Barriers” encourage allies to be move forward. Thus, with the progression of battle lines and fewer “Blind Spots” or “Holes” in which allies may hide, conflict are hastened, which in turn hastens matches.

In one embodiment of the present system, the full spaces 118 are substantially square, incorporating an area of about 89 millimeters by about 89 millimeters (3½ inches by about 3½ inches). The half spaces 126 incorporate an area of about 89 millimeters by about 44.5 millimeters (about 3½ inches by about 1¾ inches). Upon reading this specification, it should be appreciated that, under appropriate circumstances, considering such issues as user preferences, design preference, structural requirements, marketing preferences, cost, available materials, technological advances, etc., other layout arrangements such as, for example, larger or smaller spaces, spaces of alternated shapes, geometries, digital and/or electronic renderings, etc., may be sufficient.

The first surface 114 may include first distinctive indicia 130 defining at least one command zone 132 within the plurality of full spaces 118. In the present disclosure, the command zone 132 is marked by a semi-circular border encompassing two adjacent spaces. Certain games using the game board 102 begin with players placing their chosen hero cards in a respective command zone. In the present disclosure, the command zone 132 adjoins at least one of the peripheral edges 110, as shown. The significance of the above-described arrangements will be highlighted in the later descriptions relating to Ally and Hero cards and mechanics of “Venture” and “Range during gameplay.

The first surface 114 may further include second distinctive indicia 134 defining at least one neutral-zone half-space 136 within the plurality of half spaces 126 located along the neutral line 124. Each abuttable edge 112 of the game-board module 104 includes an edge length 138 (as indicated in FIG. 2) with the neutral-zone half-space 136 located near a midpoint of the edge length 138, as shown. Referring to FIG. 3, the neutral-zone half-space 136 is configured to form at least one neutral-zone full-space 142 when the abuttable edge 112 is abutted with the at least one other abuttable edge 112 of the game system 100.

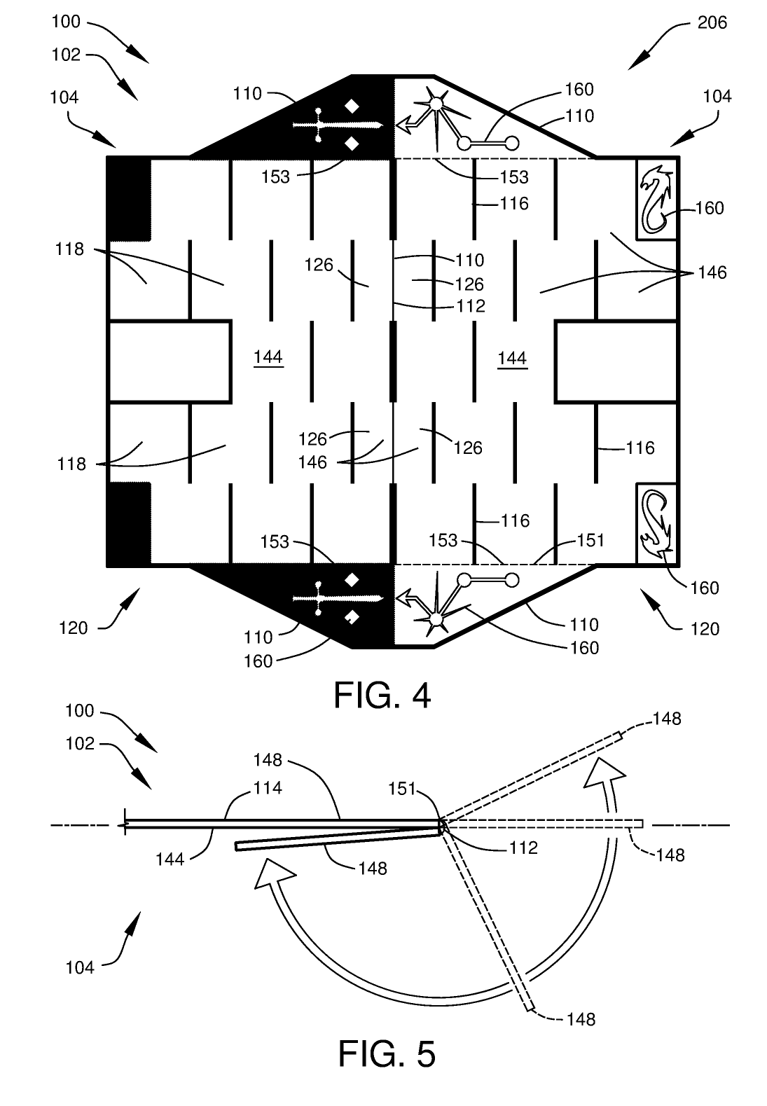

FIG. 4 is a bottom plan view of the opposing side of the game board 102 of FIG. 3, according to an embodiment of the present disclosure. The opposing side of the game board 102 includes a second surface 144 also containing graphical delineations, including an arrangements of parallel lines or hash marks 116 defining a plurality of full spaces 118 for the placement of game cards 106 during gameplay. The plurality of full spaces 118 are arranged in rows 120, as shown.

In addition, the second surface 144 includes a group of half spaces 126, each one identifying one half of a positional piece location identified herein as game card location 146. The plurality of half spaces 126 fall along the abuttable edge 112 and are configured to form full spaces 118 when the abuttable edge 112 is abutted with at least one other abuttable edge 112 of the game system 100, as shown in FIG. 3.

The rows 120 of full spaces 118 and half spaces 126 are arranged in a contiguous relationship, as shown. Moreover, the plurality of full spaces 118 of a row 120 are arranged in a staggered relationship 128 with respect to the plurality of full spaces 118 of an adjacent row 120. Similarly, the row of half spaces 126 are arranged staggered relationship 128 with respect to the plurality of full spaces 118 of the adjacent row of full spaces 118. It is noted that the rectangle of the secondary circle depicts another Command Zone, although with a slightly different look and alignment. The Command Zone may represent and be rendered as an additional space on the second surface 144, as shown. Upon reading this specification, it should be appreciated that, under appropriate circumstances, other layout arrangements such as, for example, implementing a Command Zone as a separate game component that is off the standard field, etc., may suffice. In this arrangement, a Command Zone of the second surface produces a half square. This half square may have indicia identifying it as part of the off board Command Zone, if such an off board Command Zone is used.

As diagrammatically illustrated in FIG. 4, some embodiments of the game system 100 further include thematic indicia 160 graphically depicting at least one theme related to the multi-player card game described below. Themes may include graphical depictions of characters including heroes and allies, depictions of energies possessed by the characters, battle scenarios, etc. Players may have differing graphic zones with respect to player half-boards providing an opportunity for different board zones to be sold, marketed, and collected.

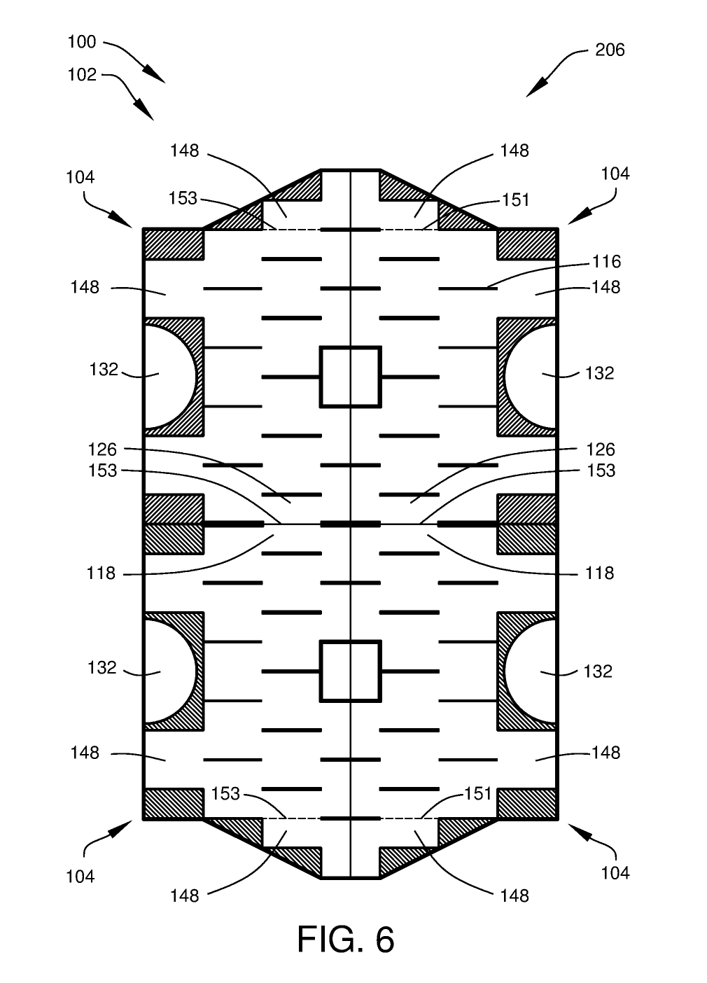

FIG. 5 is a partial side view of the game-board module 104 of FIG. 1, according to an embodiment of the present disclosure. One feature of the game-board module 104 is that the planar sections 148 forming the module are joined together such that the planar sections 148 can be folded so as to overlie one another, or unfolded to lie in a substantially common plane 109. In one embodiment of the present system, the game-board module 104 is constructed from a thin but durable material that may be folded, as required. In another embodiment of the present system, each game-board module 104 includes three substantially rigid and planar sections 148 connected together by a pair of living hinges 151. Each living hinge 151 may be made from the same material as the planar sections 148 it connects, although flexible reinforcements may also be included if additional durability is desired. The material at the living hinge 151 may be thinned or partially cut to allow the rigid planar sections 148 to bend along a fold line 153 of the hinge. The fold line 153 of each living hinge 151 extends continuously across the board to allow the planar sections 148 to be folded adjacent either the first surface 114 or the second surface 144, as shown. When folded, a new abuttable edge 112 is formed along fold line 153, as shown in FIG. 6. The game-board module 104 may be constructed from a printable cardboard material. Optionally, an engagement bracket may be added to the abuttable edges 112 enable the edges to remain in a selected relationship during play. In one embodiment of the system, the material of the board may be metallic. In this version, a flat magnet may be used to stabilize adjacent abuttable edges.

FIG. 6 is a top plan view of a four-player game board 102 of the game system using folded game-board modules 104, according to an embodiment of the present disclosure. When folded, a portion of the full spaces 118 form at least one set of half spaces 126 with the set of half spaces 126 located so that they are contiguous with the new abuttable edge 112 formed after folding. The half spaces 126 are again configured to form a set of full spaces 118 when abutted with at least one other abuttable edge 112 of the game system 100, as shown. Many board configurations are possible using the adaptability of the modular folding design. FIG. 6 illustrates what could be a four-versus-four team match using folded modules. In this example, gameplay is organized around “odds” sides versus “evens” sides wherein “odds” start first at one end while “evens” start at an opposing end.

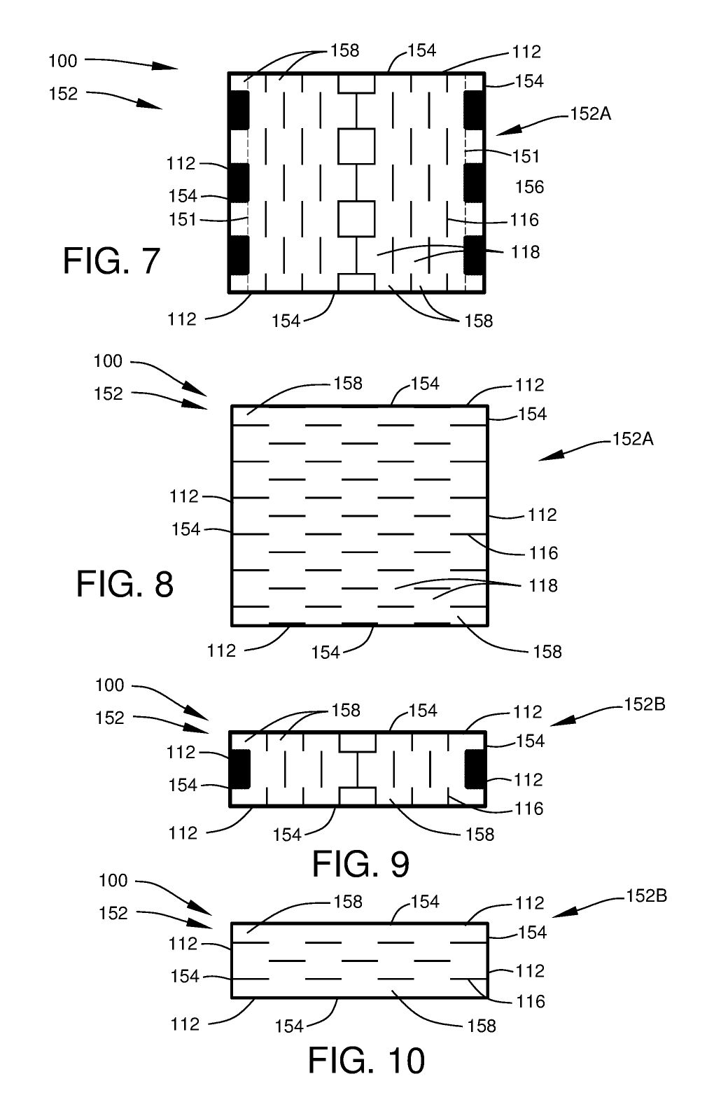

As illustrated in FIG. 7 through FIG. 10, the game system 100 further includes a range of leaflet modules 152, which may be used to further customize the fields of play. FIG. 7 is a top plan view of a leaflet expansion module 152A of the game system 100, according to an embodiment of the present disclosure. FIG. 8 is a bottom plan view of the leaflet expansion module 152A of FIG. 7, according to an embodiment of the present disclosure. FIG. 9 is a top plan view of an alternate leaflet expansion module 152B of the game system 100, according to an embodiment of the present disclosure. FIG. 10 is a bottom plan view of the alternate leaflet expansion module 152B of FIG. 9, according to an embodiment of the present disclosure.

The leaflet modules 152 may be constructed from a thin but durable material that may be folded, as required. Alternately, each game-board module 104 may include substantially rigid and planar sections connected together by living hinges 151, as shown in FIG. 7. The leaflet modules 152 may be combined with the above-described game-board modules 104 to produce additional custom game board configurations. The illustrated leaflet expansion modules 152 of FIG. 7 through FIG. 10 each include a plurality of peripheral leaflet edges 154, the plurality of peripheral leaflet edges 154 containing at least one abuttable edge 112 configured to be placeable in abutment with at least one other abuttable edge 112 of the game system 100.

Each leaflet expansion module 152 includes a first leaflet surface 156, having depicted thereon a third plurality of full spaces 118 each one identifying a game card location, the third plurality of full spaces 118 arranged in rows. In addition, each leaflet expansion module 152 includes a third plurality of half leaflet spaces 158, each one identifying one half of a game card location, the third plurality of half leaflet spaces 158 arranged to be contiguous with the abuttable edge 112 of the leaflet module and configured to form a group of full spaces 118 when the abuttable edge 112 of the leaflet module is abutted with at least one other abuttable edge 112 of the game system 100.

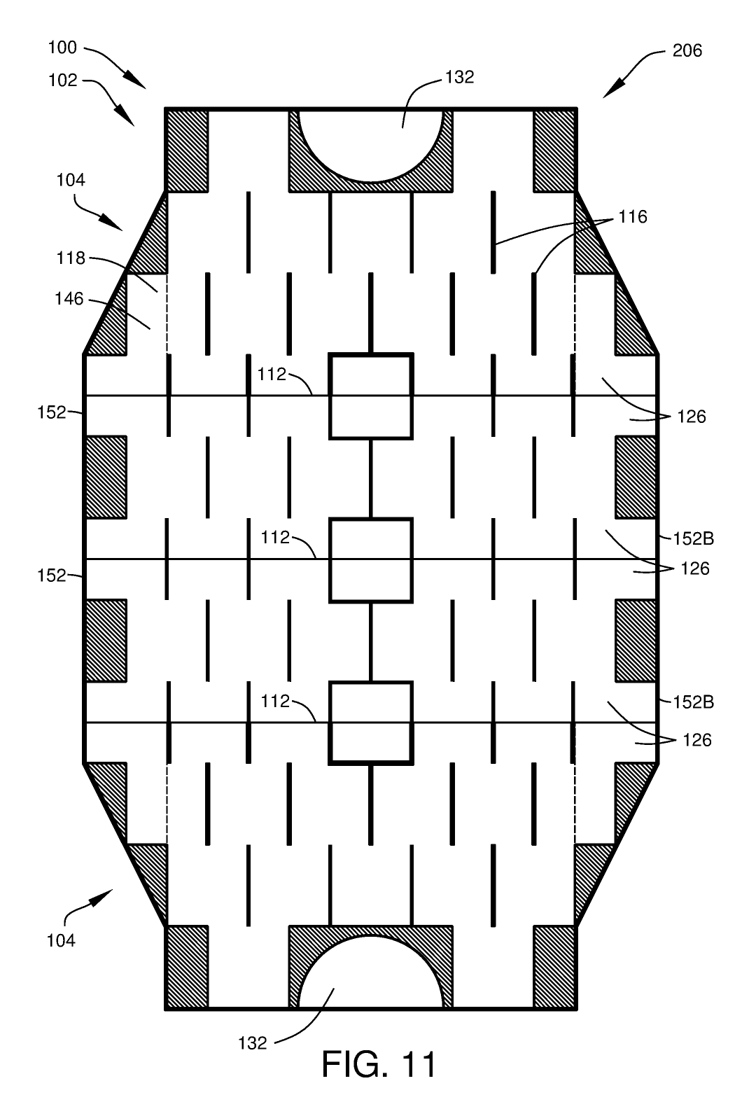

FIG. 11 is a plan view of an alternate game board 102 using the leaflet expansion module 152 of FIG. 9, according to an embodiment of the present disclosure. Upon reading this specification, it should be appreciated that, under appropriate circumstances, considering such issues as user preferences, design preference, structural requirements, marketing preferences, cost, available materials, technological advances, etc., other layout arrangements such as, for example, using more or fewer leaflet modules, leaflets of alternated shapes, geometries, etc., may be sufficient. It is again noted that, the game-board modules and the leaflet modules may be permanently joined together to for a unitary game board.

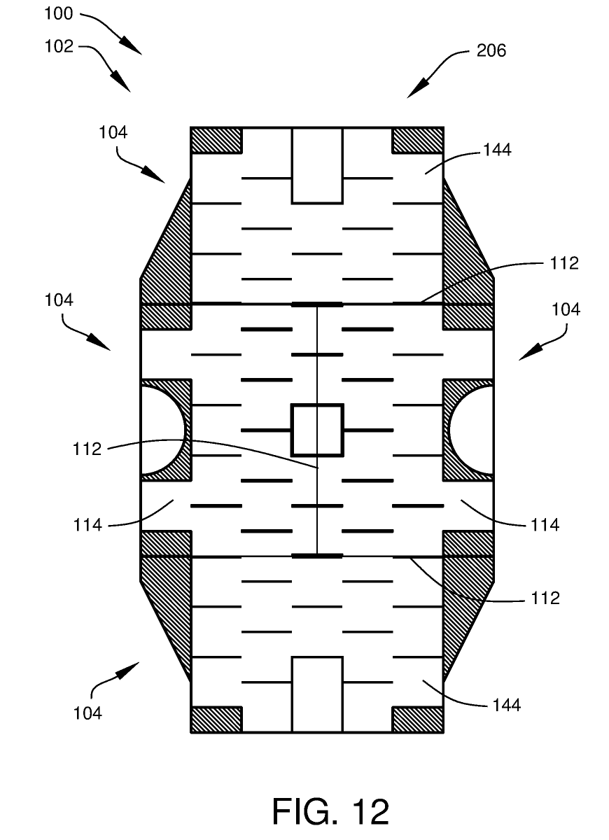

FIG. 12 is a plan view of an alternate game board 102 assembled using four of the game-board modules 104 of FIG. 2, according to an embodiment of the present disclosure. FIG. 12 shows a four-player round-table configuration generated by folding two of the four game-board modules 104, as shown. The alternate game board 102 of FIG. 12 uses both the first surface 114 and the second surface 144 of the game-board modules 104 to form the field of play 206.

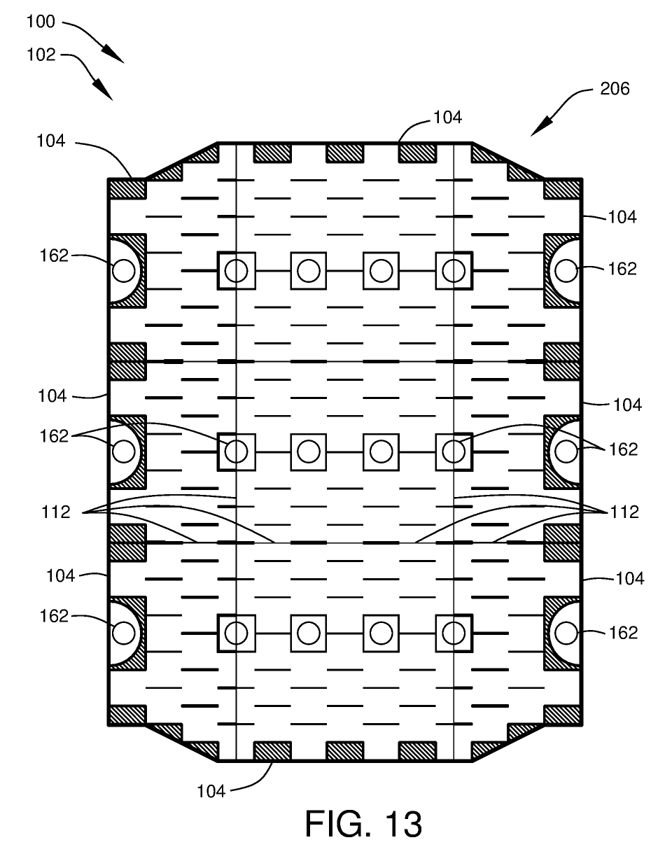

FIG. 13 is a top plan view of a multi-player game board 102 of the game system 100 using folded game-board modules 104, according to an embodiment of the present disclosure. Two players may customize a field of play 206 as large as they desire. One additional mechanism that may be employed are strategic portals. FIG. 13 illustrates a two player “portal” version of the game board. In this arrangement, if a player's hero or pawn occupies a portal space 162, then they may call reinforcements to that space instead of to first battle line.” It should be noted that the hero themselves may “Portal” between controlled locations if desired.

In some embodiments of the game system 100, the game-board modules 104 and game cards may be electronically displayed or projected. In one embodiment, electronic game boards and game cards may be implemented as an online game or as a stand-alone computer application. For example, a non-transitory computer-readable medium may store instructions that, if executed by a computing system having a processor, cause the computing system to perform operations implementing the presently-described system in a virtual form. In one implementation of the present system, two electronic devices, such as computer tablets or similar screen-type devices, may be linked such that the two device screens form the two parts of an entire field.

Referring again to FIG. 1, the game system 100 may further include set of instructions 155, wherein the game system 100 is arranged as a kit 170. The instructions 155 may detail functional relationships in relation to the structure of the game system 100 (such that the game system 100 can be used, maintained, or the like, in a preferred manner). The instructions 155 and rules to the game may also be available to be “download” from a website.

The kit 170 may include at least one set of game cards 106, each game card 106 of the set including at least one game-card attribute 108, the at least one game-card attribute 108 defining an action in accordance with the game rules such that the gameplay proceeds according to a series of steps taken by each player with respect to the games-card attributes 108 in active play.

It is important to note that the above-described game-board modules and leaflets may be combined to form a single unitary game board, Thus, “Complete” or “Whole” renditions of the game may be made (including versions implemented in digital formats). Furthermore, games solely using positional pieces may also benefit from the customizability of the game board module.

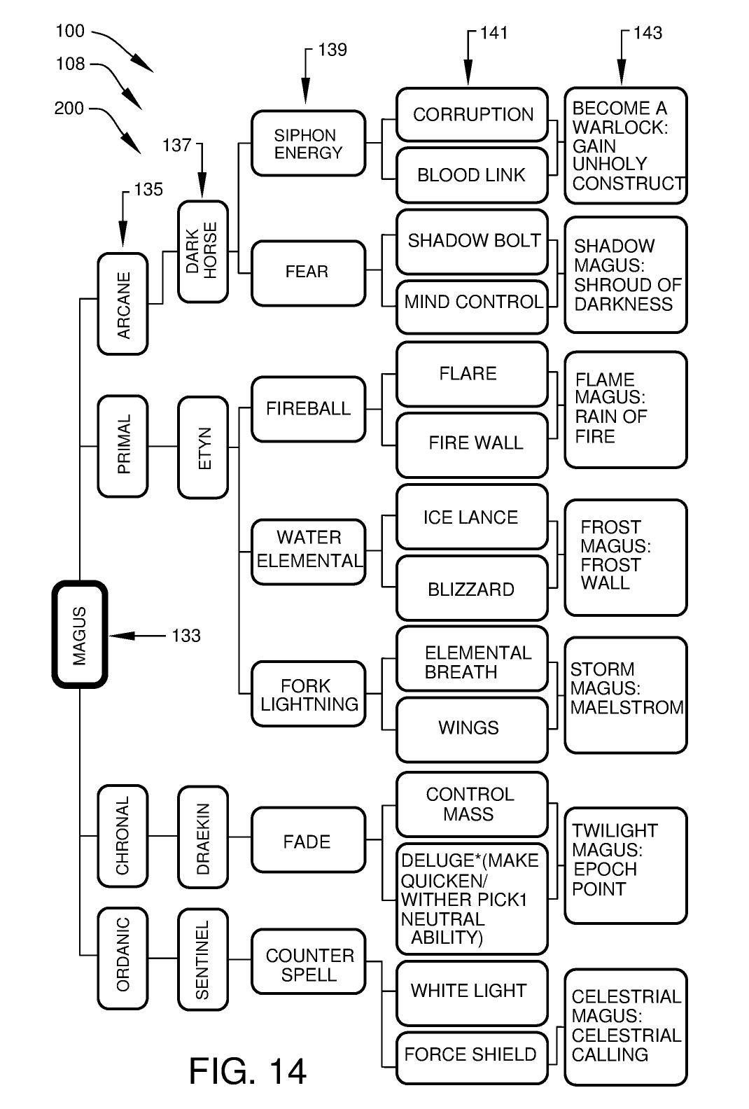

As illustrated in FIG. 14 through FIG. 16, the game-card attributes 108 may be of a series in relation to a mastery scheme. The game-card attributes 108 may further enable command-zone schemes 202, and a resource schemes 204. The mastery scheme 200 allows each player to assemble, from the set of game cards 106, a custom subset of the game cards 106. The mastery scheme 200 establishes a class-based structure within the custom subset at least including a hero-class and at least one other game-card class, as further described below. In addition, the game-card attributes 108 at least enable a command-zone scheme 202 by which players may position a game card 106 from the hero-class 208 in at least one command zone 132 within a field of play 206, as shown. The game card 106 from the hero-class 208, when so positioned, is capable of leveraging at least one game-card attribute 108 of the at least one other game-card class within the field of play 206; The resource scheme 204 allows a player to cost turn-by-turn gameplay actions, as further described below.

The following disclosure generally describes the rules and gameplay features of the trading card game 300 of game system 100. The goal of the trading card game 300 is to defeat the other player's hero by bringing their vitality to zero before they can do the same to the opposing hero.

Each player plans a strategy by assembling a custom card deck from the games card library. This constitutes a meta-game, since before engaging in any matches, players are challenged to construct the best strategies that may be developed from the mixing and matching of cards in the card library. The trading card game 300 utilizes a mastery system that functions to limit the sheer volume of cards available to a class, while allowing unprecedented choice and diversity for how classes may be structured. Upon choosing a hero class card, players are directed to allocate a limited number of points in that hero's associated mastery path. Points are allocated to unlock different path levels that grant the use of certain cards to be included in that hero's deck.

Additionally, points that are spent at the deepest path levels, unlock enhancements written on these cards from prior point selections that would be unavailable to other hero's with shallower secondary-selections on the same path. If points are not spent on certain levels or paths, the cards associated with those levels and paths will not be available to be integrated into that player's deck. after choosing a hero class and mastery path, players then have access to neutral cards and class common cards that they may elect to include or exclude from their deck, with a limit of three copies of any non-unique card, and one copy of any unique card to a predefined limit per deck. When a player is not be satisfied with the initial cards that they draw, the standard rules of the game allow for a “Mulligan” in which a player may reshuffle and redraw before beginning a match. Players may change heroes, classes, mastery selections and common cards as often as they like before but not during any match. From there, players may face opponents on the field of play attempting to execute the strategy of their deck and luck of drawing timely cards to secure their victory.

Before describing how to begin play, the following notes on what abilities and allies are provided.
Abilities: Generally these are cards or actions that may be drawn or executed for a cost and usually have an instant effect such as damage healing or hindering the actions of other players. Most abilities are limited to a certain “range” of effect. M, they are called at a cost and when available after being drawn from a players deck and into their hand.
Allies: Agents that function similarly to heroes but are called at a cost and commanded by heroes to move and influence the field of play. They are many times the primary agent by which to secure a victory. Complimentary abilities and stats vary among ally cards.
Allies deemed as unique may only have one copy active on the field of play even if an opponent has the same copy in their hand.

### Beginning the Trading Card Game

Command Zones:

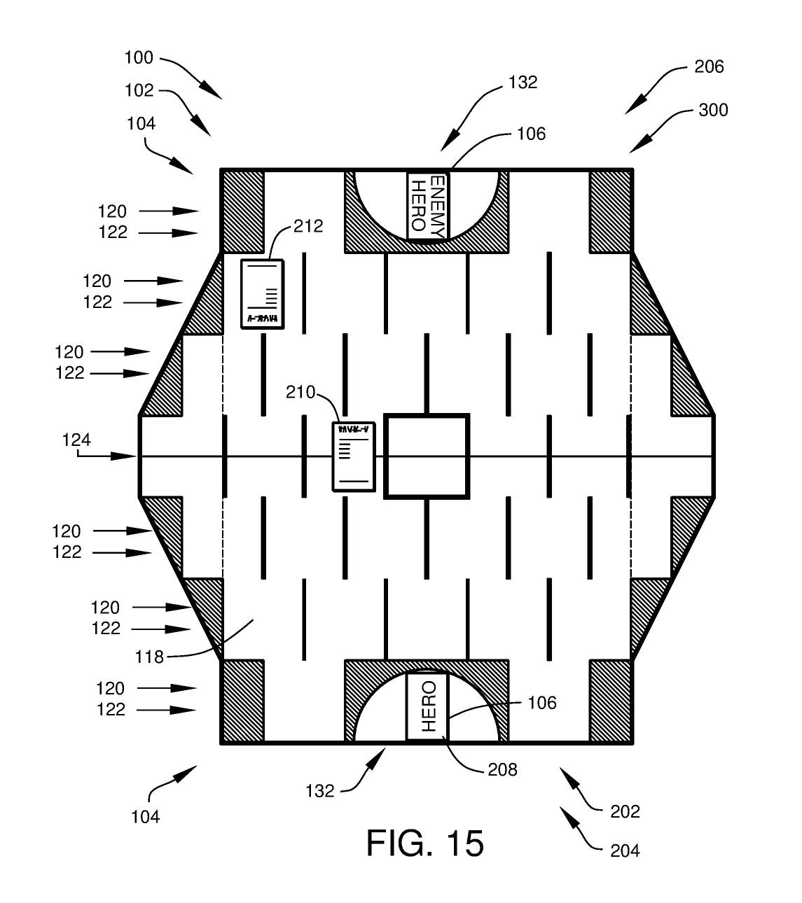

Players begin the game with their chosen heroes located in their command zone (see FIG. 15). It is again noted that the command zones on the game board may represent and be rendered as two additional game squares.

The command zone system is important because the advantages a player receives while their hero occupies the zone is significant enough to keep their hero from moving aimlessly at the start of a match where no allies may have yet been called or items and other objects such as tokens placed on the field (and not without great risk during a match), which promotes orderly and consequently easier to follow strategic play. In addition, the advantage system itself balances the integrity of executing trading card game deck strategy with the action attributed to strategic game board pieces.

While a player's hero remains in a command zone they are able to “leverage” that hero's unique abilities and other card abilities in their deck through a friendly ally position they may control on the field not just from their current hero position. In this way, a hero's forces can be seen as trained extensions and enables hero's the chance to use their abilities to attack each other directly though they are at opposing ends, and influence the field of play while strategically remaining as far from danger as possible. It is noted that heroes having the choice to attack other heroes directly, if able, is a common TCG strategy that would not be readily transferrable to positional board pieces without the novelty of the Command Zone A hero may be forced to abandon their command zone or they may choose to, but forfeit this advantage if they do so, until they are able to return.

Getting Started—the Cost or Resource System:

Another defining element of the trading card game 300 is its cost or resource system. When players make mastery selections for their heroes they are also choosing the type of energy their hero has mastery in. There are four types of energy that govern the costs of allies and abilities that may be called onto the field, which are: *Ordanic, *Chronal, Arcane, and Primal. *Ordanic and Chronal denote creative terms.

The energy type path in which a hero has mastery is deemed as that hero's mastery energy. The remaining energy types are deemed as radical energy to that hero. The difference between mastery energy and radical energy is how they are acquired and stored. mastery energy and its capacity begins at the value one at the beginning of each game and grows at the start of each turn by a factor of one until reaching a predefined automatic limit. Upon reaching the auto-limit, mastery capacity may be increased by a player “sacrificing” a card at the beginning of a turn. Most importantly, when mastery energy is spent during a turn it always recharges to its maximum capacity at the beginning of the next turn. Radical energy has no limit however, and while it is gained at the start of each turn by a factor of one, it is spread over three energy types and does not recharge to its previous amount once spent but must be saved up all over again. In this way, abilities that require a different energy type from a hero's mastery may still be used but to lesser degree. This also serves to further diversify heroes of the same class while raising the level of unpredictability for how an opponent's class may be structured. With the physical game, color-coded energy blocks may be acquired from a pool and put back into the pool to keep track of and indicate the energy type resources that are being collected and spent.

### Energy Resources Turn-by-Turn

Table 1 demonstrates how mastery energy and radical energy is gained and reacquired on a turn-by-turn basis. This example is through 10 turns and the hero has Ordanic energy as its mastery energy. Further to this example, a five-turn auto-limit has been placed on the mastery energy, after which the player must sacrifice a card to increase the capacity. Mastery energy recharges to its acquired maximum after use whereas radical energy does not but continues to supply one charge to be allocated each turn. It is also noted that radical energy may also be acquired randomly for an additional element of chance within the game rather than manually allocated. The auto-limit may be adjusted or removed and sacrificing may be implemented earlier or removed from the system, if desired.

TABLE 1

| | Radical Energy | | | Mastery Energy | | | Radical Energy | | | Radical Energy | | |
|---|---|---|---|---|---|---|---|---|---|---|---|---|
| | gained/spent/stored | | | gained/spent/stored | | | gained/spent/stored | | | gained/spent/stored | | |
| Turn | Arcane | | | Ordanic | | | Primal | | | Chronal | | |
| T1 | 0 | 0 | 0 | +1 | −1 | 1 | 0 | 0 | 0 | +1 | 0 | 1 |
| T2 | +1 | 0 | 1 | +1 | −2 | 2 | 0 | 0 | 0 | 0 | 0 | 1 |
| T3 | 0 | 0 | 1 | +1 | −3 | 3 | +1 | 0 | 1 | 0 | 0 | 1 |
| T4 | 0 | 0 | 1 | +1 | −4 | 4 | 0 | 0 | 1 | +1 | 0 | 2 |
| T5 | 0 | 0 | 1 | +1 | −5 | 5 | 0 | 0 | 1 | +1 | 0 | 3 |
| T6 | +1 | 0 | 2 | 0 | −5 | 5 | 0 | 0 | 1 | 0 | −3 | 0 |
| T7 | +1 | 0 | 3 | 0 | −3 | 5 | 0 | 0 | 1 | 0 | 0 | 0 |
| T8 | 0 | 0 | 3 | (Sacrifice) +1 | −6 | 6 | +1 | 0 | 2 | 0 | 0 | 0 |
| T9 | +1 | −2 | 2 | 0 | −6 | 6 | 0 | −1 | 1 | 0 | 0 | 0 |
| T10 | 0 | 0 | 2 | (Sacrifice) +1 | −7 | 7 | +1 | 0 | 2 | 0 | 0 | 0 |

As seen in Table 1, the capacity for mastery energy is refilled every time. While radical energy has no limit, it takes longer to gather. If the radical energy in the above example was placed solely into one radical energy category without being spent, that one category would have 10 energy available. There are several methods that may be employed to help balance the advantage of player one gaining resources and going first. The first may be that player two would get the opportunity to sacrifice for additional mastery energy after the auto-turn limit before player one who would be delayed one turn, the second is that on player two's first turn that they are awarded two radical energy to allocate instead of one for player one.

### Starting the Game

By rolling a die with a higher number or other means to determine who goes first, each player draws ‘x’ cards. The player who won the roll (player one) does not draw an additional card at this point since they are afforded the opportunity to go first but gains one mastery energy and allocates one radical energy. If no moves can be made, or are chosen to not be made, player one ends their turn.

Player two then follows suit but may draw a card at the start of their turn while gaining one mastery energy and allocating one radical energy. At the start of player one's second turn they may begin by drawing a card and gaining energy. From this point, as long as a player's hand is not full, each player will draw a card at the start of each of their turns. Up until turn ‘x’, players will gain mastery energy and increase their turn capacity for mastery energy by a factor of one at the start of each turn until turn ‘x’ is reached. From that point, players will no longer automatically increase their mastery energy capacity but may choose to sacrifice a card from their hand in order to do so if they choose. Mastery energy will recharge to its full capacity at the start of each player's turn. Radical energy does not change, at the start of each turn players will continue to receive one radical energy they may allocate without limit, however, when radical energy is spent the limit is not recharged.

Any allies that are called onto the field from a player's hand enter play on a player's first battle line unless expressly written otherwise. Allies cannot move or attack in the same turn they are called unless otherwise indicated. At the beginning of each subsequent turn, if able, allies may then move, attack and activate abilities on the field in an effort to reduce the other hero's vitality to zero. If two heroes are reduced to zero at the same time the game is a draw.

### Additional Rules

The trading card game uses key-words (that may be added to or amended) to indicate exceptions. If a card possesses the key-word the exception is allowed. For example, allies that are called from a player's hand generally may not move or use abilities on the same turn unless they possess the key-word “haste” which allows for this exception. Each card is like a “schedule” of rules that apply only when put into play. If there are any discrepancies between what is written on any opposing cards or effects in play, a card that specifically references or allows for an exception to a key-word or effect is the one that supersedes. For example, if an effect is in play that specifically does not allow a player's allies to benefit from haste then the exception of haste is not allowed. In large part what is written on each card includes most of the rules in the game but will vary based on the types of cards that are chosen and put into play. Players may reference the key-words and glossary to clarify what a key-word or special term written on a card means.

The diagram of FIG. 14 illustrates a possible mastery path using a relational hierarchy of game-card attributes 108. More specifically, the diagram of FIG. 14 shows the categories of class 133, entry level 135, energy level 137, disciplined level 139, proficient level 141, and mastery level 143. In this model, a total of seven points may be allocated. A mastery must be chosen. In all paths, for all classes, entry-level must be selected with a point before proficiencies can be selected. All proficiencies in a path must be selected before selecting mastery. Remaining points can be used in a secondary path as minors. Cards in a secondary energy path may be included in a players deck but without the allowance or capability for the mastery enhancement written. Cards associated with a mastery series have two abilities written on the card; a secondary ability which is the ability in its basic form, and the Mastery ability which is an advanced version of the secondary ability or an additional option granting more flexibility for a player to possess.

### Command Zones, Battle Lines and Leveraging Abilities

FIG. 15 is a diagram generally illustrating aspects of gameplay within a standard game board 102 defining the field of play 206. It is again noted that the plurality of full spaces 118 are arranged in staggered rows 120, as shown. The rows 120 extend from one side of the board to the other and are referred to as battle lines 122. The closest battle line 122 to each player is referred to as their first line, the next their second line, the next their third line etc. In this configuration, the fourth line is the mid-point between the opposing sides and is referred to as the neutral line 124.

Each space is a range or distance of one. A friendly ally 210 may only attack if in a range of one. A game card 106 from the hero-class 208 (also referred to herein as a “hero”) has an ability that may strike in ally within a range of two. As illustrated in FIG. 15, neither the friendly ally card 210 nor the hero are within range to strike the enemy ally card 212. However, since the game card 106 from the hero-class 208 is in the command zone 132, he may call anability, for an energy cost, that can strike an enemy within a range of two and leverage the friendly ally position to that target and strike the enemy ally card 210. It should be noted that ranges will vary for heroes and allies and are not specifically limited to a range of “one” and “two” respectively.

Command zones afford each player's hero an equal advantage that neither one should abandon lightly. So long as heroes remain in their command zone they may leverage friendly ally positions to execute many of their ability attacks. Some or many ability attacks may be drawn and subsequently called from a player's hand. This means that for every hero's ability that reads, for example, “in range of two,” if a hero has an ally in play in enemy territory, that hero may use its ally's position as its point of range and any targets within range of two of that ally may be targeted. It is important to note that “within range of two” also includes “line of sight. This works not just if a hero has an ally in enemy territory. If heroes have no allies in play or are not in their command zone, the point of range is always from the hero's position. Some abilities do however, only apply to the hero and cannot be leveraged but will clearly state “from your hero's position.” otherwise, the ability for a hero to leverage their forces from a command zone remains in effect. *Heroes may not benefit from an opposing hero's command zone. It should be noted, especially with regards to larger multi-player board configurations where players occupy the same side of the field, that when the “blacked” out half-squares of adjacent modules abut together to form the fully blacked out squares, the resulting space is representational of a barrier so that heroes on the same side of the field can't attack other heroes without leaving the command zone. Additionally allies called to the first battle line cannot so readily attack opposing heroes.

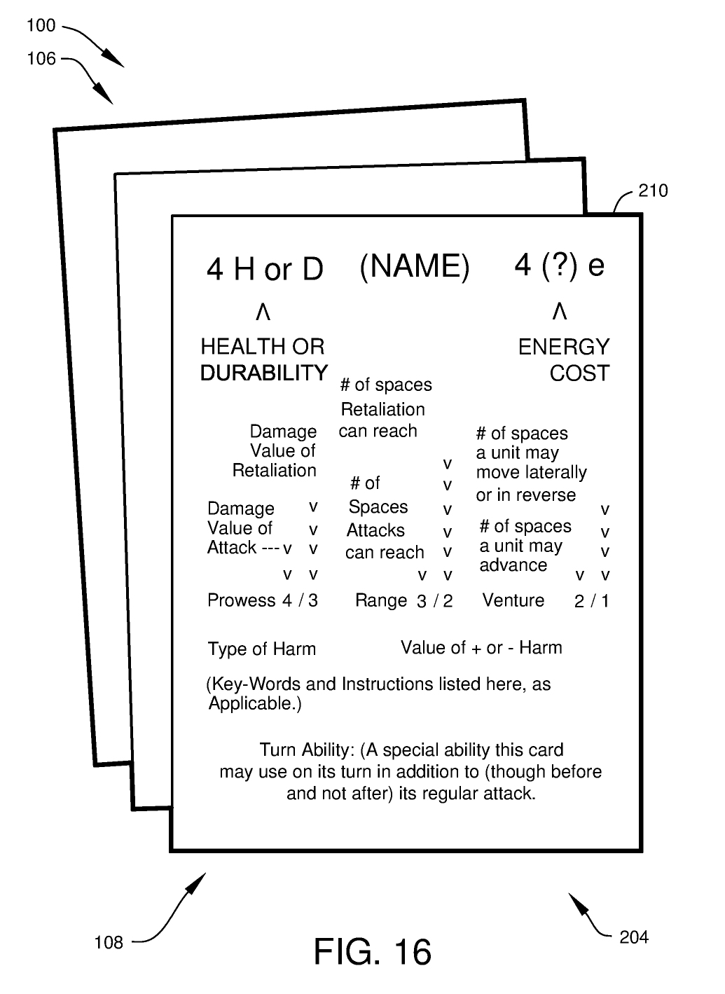

FIG. 16 is a diagram illustrating an example arrangement of game-card attributes 108 of a game card 106, according to an embodiment of the present disclosure. FIG. 16 is an example and explanation of what may typically be included on a hero ally card 210. All allies have health (and sometimes durability) which is generally the amount of damage an ally can take until it is defeated. Damage received is subtracted from this value and healing received is added back to this value up to its maximum. Any cards that effect the maximum range is a rating of distance as measured by spaces that an ally's damaging attacks or abilities can reach. The first value is how far they can reach when they are the aggressor; the second value is how far they can reach when they are retaliating. Any targets outside of an ally's range cannot be targeted by that ally. Health that an ally can have will be expressly written.

Harm is an intentionally negative term that is synonymous with damage. if an ally has a weakness to a type of damage a (+) sign will precede the value and will be added to the total damage of an attack, if an ally has resistance to a type of damage a (−) sign will precede the value and will be subtracted from the total damage. Types of harm will be listed (if not listed, the value is zero).

Venture is a rating of an ally's ability to travel across terrain. Some allies may be quick to rush into danger but less skilled at navigating away from it. The first value is how many spaces an ally may move forward on a turn, the second value is how many spaces an ally may retreat or move laterally. Only one value may be used per turn—they are not combined. *if the second value is three an ally may move two spaces to the side and one space back for a total of three, but may not advance in the same turn.

Prowess is a rating of an allies overall fighting ability. Some are better at attacking and others are more skilled when defending or retaliating. As a general rule, allies go by the first value (attack) when they are the aggressor (usually on your turn), and the second value (retaliation) when attacked by an enemy (usually on enemy turn).

Allies do not retaliate when they are the target of abilities, they may only retaliate when physically attacked and in range. All attacks, no matter how high the damage value, deal only one point of damage to targets with durability unless additional durability damage is expressly written. Up to two allies may occupy the same space. Allies may not occupy the same space as a construct unless expressly written. If an ally occupies the same space as an enemy ally at any time and the opposing ally is able to retaliate, a conflict is implied and that ally must attack the enemy and is not able to venture past unless expressly written otherwise or if moving away from a shared space on another turn. Allies may not venture or continue to venture after attacking or using an ability unless expressly written otherwise. Traps may be placed face down on a space not occupied by an enemy or just off the field of play depending on the trap. When using a defensive ability on an enemy's turn, your hero must have the required energy still available from their previous turn as mastery energy does not recharge until the start of a players turn.

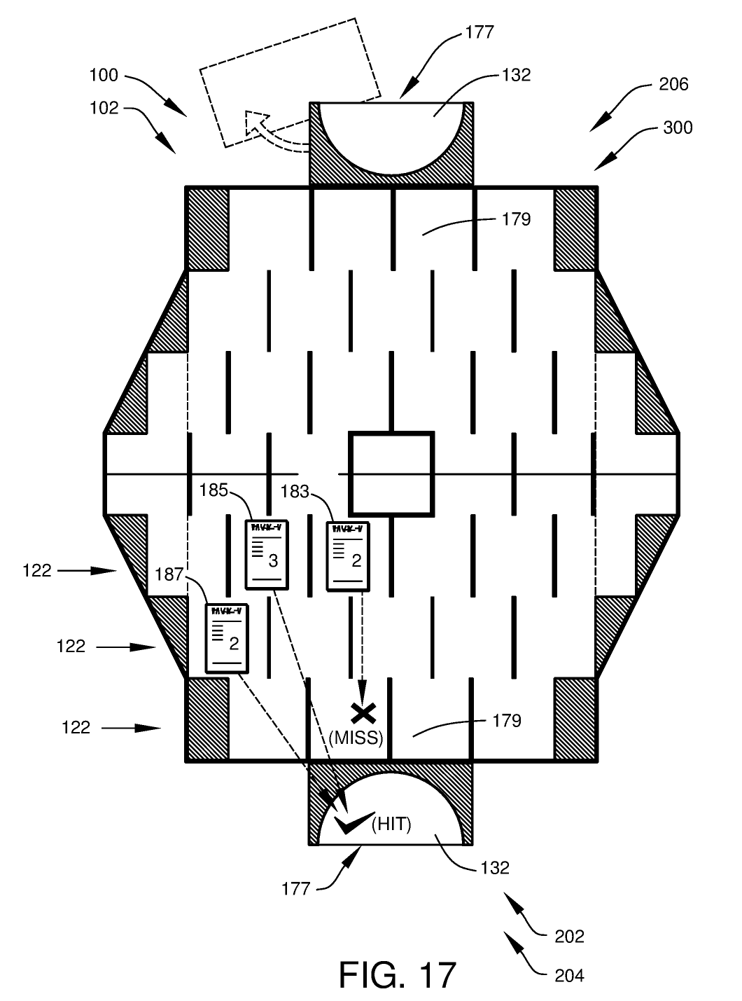

FIG. 17 is a top plan view of an alternate game board 102 of the game system 100 using separate Command Zone modules 177, according to another embodiment of the present disclosure. In some embodiments of the present system, a command zone 132 may be implemented as a separate game component that is off the standard field. In this arrangement, the command zone 132 is part of a command-zone module 177, which may be placed on or near any two spaces of the board, if such a customized field of play is desired. Note that two additional spaces 179 are revealed on the board in this arrangement, thereby increasing by one (1), the distance or range that a hero in the command zone 132 may be targeted. The example game arrangements of FIG. 17 show that an enemy 183, having a range of two, will miss the command zone 132 when attacking from the third battle line 122. However, an enemy 185 having a range of three will hit the command zone 132 from the same battle line. An enemy 187, having a range of two, will hit the command zone 132 when attacking from the second battle line 122, as shown. If a hero leaves the command zone 132, they may do so anywhere on the first battle line 122 and may return from anywhere on the first battle line 122. It is further noted that allies called into play are still started on the first battle line 122.

The game instructions 155 may include the following descriptive keyword glossary, which is provided as a reference to rule descriptions and may also function to save space for less common and unique descriptions on the game cards.

### Glossary of Game Terms

Term Description
Ability: Cards that have an instant effect and are almost always used up on the turn they are called.
ae: Arcane energy. Sub-sets include shadow and blood.
All Harm: Refers to all damage sources.
Ally: The bread and butter of most decks, an ally is an agent for a hero capable of attacking, defending and is needed to lay claim to a strategic position on the field from which a hero can effect change on the field.
Ambush: After attacking an enemy, even if within that enemy's range, that enemy will not be able to inflict retaliation damage.
AOE: Area of effect. Effects all spaces within its numbered range.
Blink: May return to its owner's first line on its turn and back to its last position on its next turn if its last position remains unoccupied.
ce: Chronal energy.
Class: Any one of seven types for which cards and abilities are designed for their exclusive use: Magus, Warrior, Ciyan*, Varian*, Judge/Jagan*, Sage, and Ranger (* a creative term).
Construct: Fortifications or tools of war that have durability instead of health built to bolster your forces.
Deck: The library of minimum/maximum of cards plus a hero card that each player must put together to compete on the field of play.
Defender: Even when being attacked by an enemy on an enemy's turn it is considered the aggressor.
Defensive Ability: Cards that have an instant effect and are almost always used up on the turn they are called but which require a certain situation in order to be effective.
Discarded/Defeated: Place in the graveyard.
Discipline: The second tier on a mastery tree required to be selected before accessing the third tier.
Durability: The representation of vitality for a structure or creation, if it reaches zero that structure or creation is destroyed.
Entry: The first tier on a mastery tree required to be selected before accessing the second tier.
Exile: Removed from the game.
Flying (1): A distance of one space is added between this ally and allies without flying. This distance is ignored when that ally chooses to attack and when its target subsequently retaliates. May move over spaces not obstructed by anything else with flying (1) or higher but may not end a turn on a space occupied by two allies or a construct.
Flying (2): A distance of two spaces is added between this ally and ally's without flying, and one space is added between this ally and ally's with flying (1). This distance is ignored when that ally chooses to attack and when its target subsequently retaliates. May move over spaces not obstructed by anything else with flying (2) or higher but may not end a turn on a space occupied by two allies or a construct.
Flying (3): A distance of three spaces is added between this ally and allies without flying, two spaces between this ally and allies with flying (1), one space with allies with flying (2). This distance is ignored when that ally chooses to attack and when its target subsequently retaliates. May move over spaces not obstructed by anything else with flying (3) but may not end a turn on a space occupied by two allies or a construct.
Frozen/Immobilized: May not venture, attack, or use any abilities.
Graveyard: Refers to the designated spot where cards that have been defeated or discarded are stacked. As there are abilities that allow for cards to be retrieved from this stack it is important to keep these cards together.
Hand: Refers to cards a player has drawn from their deck but has not yet put into play on the field.
Haste: May venture, attack, or use abilities in the same turn it is called.
Health: The representation of vitality for an ally or hero, if it reaches zero that hero or ally is defeated.
Immunity: Un-damageable by a type of harm.
Item: Items give their wielder or area of effect a permanent benefit so long as it remains in play. more often than not they effect a single target (Also Includes Armor and Weapons and Traps)
Leech: Gains a portion of damage dealt as healing.
Mastery Selection: The final tier on a mastery tree that grants a title & unlocks enhancements for aligned cards in a mastery path.
Mastery Tree: The chart of optional paths to special calls available to class by the allocation of talents.
me: Mastery energy. Refers to the energy type of a hero's chosen mastery.
oe: Ordanic energy. sub-sets include light, white, holy, divine
Path: Any leg leading to a mastery selection on a mastery tree.
pe: Primal energy. Sub-sets include fire, frost, water, air, lightning (earth as well but its damage is classified as physical).
Proficiency: The third tier on a mastery tree required to be selected before making a mastery selection.
Protector: Cards in one of the two spaces behind may not be targeted by an enemy.
Resurface: A tunneller that comes to the surface.
Rooted: May not venture but may attack or use abilities if in range.
Stealth: May not be targeted unless detectable by an enemy.
Support Ability: Cards that have an effect on the field of play but are meant to remain effective beyond a single turn.
Support Item: Items that usually affect the entire field.
Talents: A point of mastery that may be allocated on the mastery tree.
Tunnel: May only venture 1/1 and have a range of is un-targetable and un-damageable by allies and effects on or above the surface unless otherwise stated. May not attack allies on or above the surface but may attack others with tunnel. Allies that are tunneled cannot share the same space at any time.
Turn Ability: A special ability that an ally may use in addition to (though before and not after) its regular attack.
Unpreventable: Supersedes any harm reductions except immunity.
Un-targetable: Cannot be targeted.
xe: Radical energy. Refers to the energy types outside of a hero's chosen mastery.

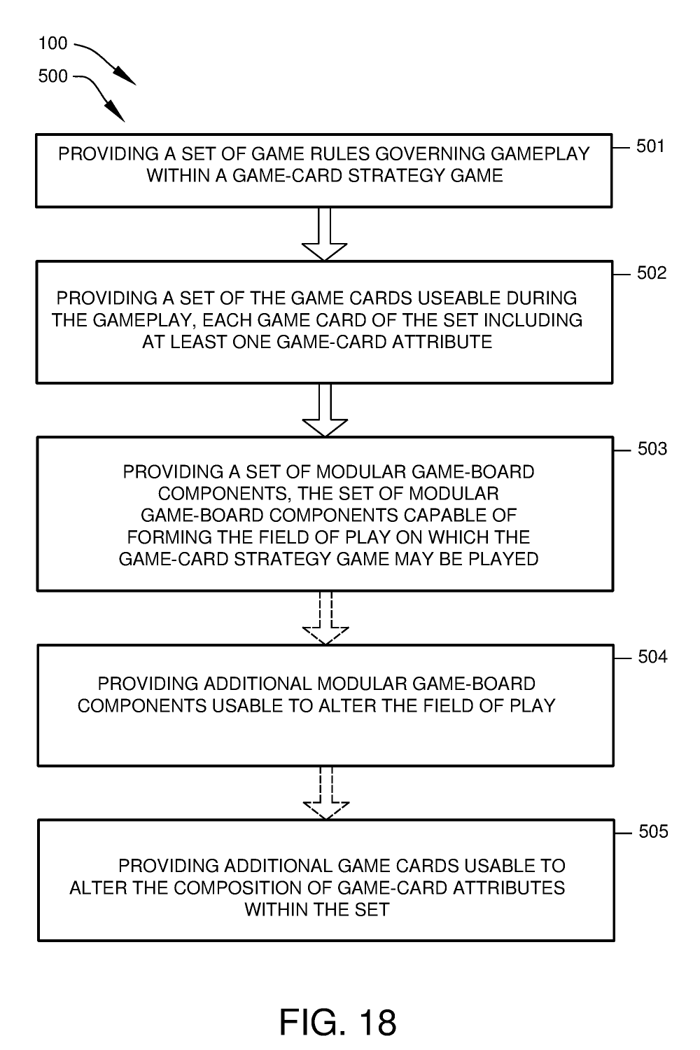

FIG. 18 is a flow diagram illustrating a method 500 relating to strategy games utilizing game cards 106, according to an embodiment of the present disclosure. In particular, the method 500 may include one or more components or features of the game system 100 as described above. As illustrated, the method 500 may include the steps of: step one 501, providing a set of game rules governing gameplay within a game-card strategy game; step two 502, providing a set of the game cards useable during the gameplay, each game card of the set including at least one game-card attribute, the at least one game-card attribute defining an action in accordance with the game rules such that the gameplay proceeds according to a series of steps taken by each player with respect to the games-card attributes in active play, the at least one game-card attribute at least enabling a mastery scheme allowing each player to assemble, from the set of trading cards, a custom subset of the game cards, the mastery scheme establishing a class-based structure within the custom subset at least including a hero-class and at least one other game-card class, a command-zone scheme by which players may position a game card from the hero-class in at least one command zone within a field of play, the game card from the hero-class, when so positioned, is capable of leveraging at least one game-card attribute of the at least one other game-card class within the field of play, and a resource scheme allowing a player to cost turn-by-turn gameplay actions; step three 503, providing a set of modular game-board components, the set of modular game-board components capable of forming the field of play on which the game-card strategy game may be played, the modular game board including features enabling the mastery scheme, the command-zone scheme, and the resource scheme during the gameplay.

In addition, the method 500 may include the steps of: step four 504, providing additional modular game-board components usable to alter the field of play; and step five 505, providing additional game cards usable to alter the composition of game-card attributes within the set.

It should be noted that steps 504 and 505 are optional steps and may not be implemented in all cases. Optional steps of method of use 500 are illustrated using dotted lines in FIG. 18 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods (e.g., different step orders within above-mentioned list, elimination or addition of certain steps, including or excluding certain maintenance steps, etc.), are taught herein.

Game cards 106 may be grouped within a library of cards. Other game elements, such as energy, etc. may be included with system. It is noted that the game board 102 may also provide a platform for strictly positional pieces similar to those used on a chess board. Alternately, “tokens” may be used in the game to represent a “spawned” or “triggered” ally or item or the reach of a construct such as a “wall” covering more than one space and of which a single card cannot fully represent. It should also be mentioned that the present game-board system lends itself to other TCG applications, sports-themed games (where the board is like a “court” or “rink”), and to military-themed TCG games. Cards and game boards may be bought, sold, or otherwise marketed using customary commercial methods. The game elements may be distributed through physical and online retailers and publishers of games. Digital versions of the game may be distributed by game console companies or by online retailers.

The embodiments of the system described herein are exemplary and numerous modifications, variations and rearrangements can be readily envisioned to achieve substantially equivalent results, all of which are intended to be embraced within the spirit and scope of the system. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A game system relating to multi-player card games, the game system including:
a game-board module including
a plurality of peripheral edges, the plurality of peripheral edges containing at least one abuttable edge configured to be placeable in abutment with at least one other abuttable edge of the game system,
a first surface having depicted thereon,
a plurality of full spaces each one identifying a positional piece location, the plurality of full spaces arranged in rows, and
a plurality of half spaces, each one identifying one half of a positional piece location, the plurality of half spaces contiguous with the at least one abuttable edge and configured to form full spaces when the abuttable edge is abutted with at least one other abuttable edge of the game system.

2. The game system of claim 1, wherein the rows are in a contiguous relationship.

3. The game system of claim 1, wherein
the plurality of full spaces of a row are arranged in a staggered relationship with respect to the plurality of full spaces of an adjacent row; and
the full spaces are substantially square.

4. The game system of claim 1, further including first distinctive indicia defining at least one command zone.

5. The game system of claim 4, wherein
The at least one command zone is located within the plurality of full spaces; and
the at least one command zone adjoins at least one of the peripheral edges.

6. The game system of claim 1, further including second distinctive indicia defining at least one neutral-zone half-space within the plurality of half spaces.

7. The game system of claim 6, wherein
each abuttable edge of the game-board module includes an edge length; and
the at least one neutral-zone half-space is located near a midpoint of the edge length.

8. The game system of claim 6, wherein the neutral-zone half-space is configured to form at least one neutral-zone full-space when the abuttable edge is abutted with the at least one other abuttable edge of the game system.

9. The game system of claim 1, wherein
the game-board module further includes a plurality of planar sections hingedly joined together such that the sections can be folded so as to overlie one another or unfolded to lie in a substantially common plane;
when folded, a portion of the full spaces form at least one set of half spaces; and
the at least one set of half spaces are contiguous with the at least one new abuttable edge and are configured to form a set of full spaces when abutted with at least one other abuttable edge of the game system.

10. The game system of claim 1, wherein the game-board modules are permanently joined together.

11. The game system of claim 1, further including
a second surface having depicted thereon
a second plurality of full spaces each one identifying a positional piece location, the second plurality of full spaces are arranged in rows, and
a second plurality of half spaces, each one identifying one half of a positional piece location, the plurality of half spaces contiguous with the at least one abuttable edge and configured to form a set of full spaces when the abuttable edge is abutted with at least one other abuttable edge of the game system.

12. The game system of claim 1, further including a leaflet module including
a plurality of peripheral leaflet edges, the plurality of peripheral leaflet edges containing at least one abuttable edge configured to be placeable in abutment with at least one other abuttable edge of the game system,
a first leaflet surface having depicted thereon
a third plurality of full spaces each one identifying a positional piece location, the third plurality of full spaces arranged in rows, and
a third plurality of half leaflet spaces, each one identifying one half of a positional piece location, the third plurality of half leaflet spaces contiguous with the at least one abuttable edge of the leaflet module and configured to form a group of full spaces when the abuttable edge of the leaflet module is abutted with at least one other abuttable edge of the game system.

13. The game system of claim 12, wherein the game-board modules and the leaflet modules are permanently joined together.

14. The game system of claim 1, further including thematic indicia graphically depicting at least one theme related to the multi-player card game.

15. The game system of claim 1, wherein the game-board module is electronically displayed.

16. A game system, the game system including:
a game-board module including
a plurality of peripheral edges, the plurality of peripheral edges containing at least one abuttable edge configured to be placeable in abutment with at least one other abuttable edge of the game system,
a first surface having depicted thereon
a plurality of full spaces each one identifying a positional piece location, the plurality of full spaces arranged in rows, and
a plurality of half spaces, each one identifying one half of a positional piece location, the plurality of half spaces contiguous with the at least one abuttable edge and configured to form full spaces when the abuttable edge is abutted with at least one other abuttable edge of the game system;
wherein the rows are in a contiguous relationship;
wherein the plurality of full spaces of a row are arranged in a staggered relationship with respect to the plurality of full spaces of an adjacent row;
wherein the full spaces are substantially square;
further including first distinctive indicia defining at least one command zone within the plurality of full spaces;
wherein the at least one command zone adjoins at least one of the peripheral edges;
further including second distinctive indicia defining at least one neutral-zone half-space within the plurality of half spaces;
wherein each abuttable edge of the game-board module includes an edge length;
the at least one neutral-zone half-space is located near a midpoint of the edge length;
wherein the at least one neutral-zone half-space is configured to form at least one neutral-zone full-space when the abuttable edge is abutted with the at least one other abuttable edge of the game system;
wherein the game-board module further includes a plurality of planar sections hingedly joined together such that the sections can be folded so as to overlie one another or unfolded to lie in a substantially common plane;
when folded, a portion of the full spaces form at least one set of half spaces;
the at least one set of half spaces are contiguous with the at least one new abuttable edge and are configured to form a set of full spaces when abutted with at least one other abuttable edge of the game system;
further including
a second surface having depicted thereon
a second plurality of full spaces each one identifying a positional piece location, the second plurality of full spaces are arranged in rows, and
a second plurality of half spaces, each one identifying one half of a positional piece location, the plurality of half spaces contiguous with the at least one abuttable edge and configured to form a set of full spaces when the abuttable edge is abutted with at least one other abuttable edge of the game system;
further including a leaflet module including
a plurality of peripheral leaflet edges, the plurality of peripheral leaflet edges containing at least one abuttable edge configured to be placeable in abutment with at least one other abuttable edge of the game system,
a first leaflet surface having depicted thereon,
a third plurality of full spaces each one identifying a positional piece location, the third plurality of full spaces arranged in rows, and
a third plurality of half leaflet spaces, each one identifying one half of a positional piece location, the third plurality of half leaflet spaces contiguous with the at least one abuttable edge of the leaflet module and configured to form a group of full spaces when the abuttable edge of the leaflet module is abutted with at least one other abuttable edge of the game system;
wherein each of the full spaces of the game system is about 89 millimeters square; and
further including thematic indicia graphically depicting at least one theme related to the multi-player card game.

17. The game system of claim 17, further including set of instructions; and
wherein the game system is arranged as a kit.

18. The game system of claim 17, further including at least one set of game cards each game card of the set including
at least one game-card attribute, the at least one game-card attribute defining an action in accordance with the game rules such that the gameplay proceeds according to a series of steps taken by each player with respect to the games-card attributes in active play, the at least one game-card attribute at least enabling
a mastery scheme allowing each player to assemble, from the set of trading cards, a custom subset of the game cards, the mastery scheme establishing a class-based structure within the custom subset at least including a hero-class and at least one other game-card class,
a command-zone scheme by which players may position a game card from the hero-class in at least one command zone within a field of play, the game card from the hero-class, when so positioned, is capable of leveraging at least one game-card attribute of the at least one other game-card class within the field of play, and
a resource scheme allowing a player to cost turn-by-turn gameplay actions.

19. A method relating to strategy games utilizing game cards, the method including the steps of:
providing a set of game rules governing gameplay within a game-card strategy game;
providing a set of the game cards useable during the gameplay, each game card of the set including
at least one game-card attribute, the at least one game-card attribute defining an action in accordance with the game rules such that the gameplay proceeds according to a series of steps taken by each player with respect to the games-card attributes in active play, the at least one game-card attribute at least enabling a mastery scheme allowing each player to assemble, from the set of trading cards, a custom subset of the game cards, the mastery scheme establishing a class-based structure within the custom subset at least including a hero-class and at least one other game-card class,
a command-zone scheme by which players may position a game card from the hero-class in at least one command zone within a field of play, the game card from the hero-class, when so positioned, is capable of leveraging at least one game-card attribute of the at least one other game-card class within the field of play, and
a resource scheme allowing a player to cost turn-by-turn gameplay actions;
providing a set of modular game-board components, the set of modular game-board components capable of forming the field of play on which the game-card strategy game may be played, the modular game board including features enabling the mastery scheme, the command-zone scheme, and the resource scheme during the gameplay.

20. The method of claim 19 further including the steps of:
providing additional modular game-board components usable to alter the field of play; and
providing additional game cards usable to alter the composition of game-card attributes within the set.
